(19) United States
(12) Patent Application Publication
(10) Pub. No.: US 2010/0072847 A1
(43) Pub. Date: Mar. 25, 2010

(54) Electromagnetically Driven Configuration of Flywheels And Rotors To Power Zero Emission Vehicles

(76) Inventors: Zane Craig Fields, Camarillo, CA (US); Marta Haley Fields, Camarillo, CA (US)

Correspondence Address: ZANE CRAIG FIELDS, 4826 175th St S.E., Bothell, WA, 98012, US

(21) Appl. No.: 12/168,105

(22) Filed: Sep. 22, 2008

(51) Int. Cl. H02K 7/02

(52) U.S. Cl. 310/153; 180/65.1

(57) ABSTRACT

An electric vehicle drive system includes an improved mechanical flywheel, rotor and friction disc assembly comprised of a plurality of coaxial flywheels, friction discs and rotors being driven by electromagnets placed on the outer circumference of the assembly containment ring and interspersed on the outsides of the assembly end plates.

### REFERENCES CITED

| | | |
|---|---|---|
| 4,358,693 | November 1982 | Palmer, et al |
| 4,538.079 | August 1985 | Nakayama, et al |
| 4,572,528 | February 1986 | McGee, et al |
| 5,117.141 | May 1992 | Hawsey, et al |
| 5,258,696 | November 1993 | Ford, et al |
| 5,436,518 | July 1995 | Kawai |
| 5,469,760 | November 1995 | Kamio |
| 5,619,087 | April 1997 | Sakai |
| 6,531,799 | March 2003 | Miller |
| 6,633,100 | October 2003 | Sato |
| 6,630,806 | October 2003 | Britts, et al |
| 6,924,574 | August 2005 | Qu, et al |
| 7,151,335 | December 2006 | Tajima |

### FEDERALLY SPONSORED RESEARCH

Not Applicable.

### FIELD OF THE INVENTION

Flywheels have long been used primarily to store and release energy. Multiple flywheel systems have been used in very few cases but again the primary goal has been that just mentioned or buffering and vibration dampening. This invention relates to the field of mechanical advantage devices and in particular that which can provide a continuous rotational force or torque/moment about a central axis or fulcrum.

This invention relates in a secondary manner to the field of kinetic energy storage by use of flywheel structures. This invention also relates to the field of electric motors and specifically that which have permanent magnet arrangements in their rotor in lieu of copper windings.

### BACKGROUND AND SUMMARY OF THE INVENTION

It is the primary objective of the present invention to provide an improved flywheel and rotor configuration in assembly; which is electromagnetically driven about a common axis while being splined to and/or journalled to a single main output shaft. This will obviate the many disadvantages associated with the conventional approach to powering electric vehicles, the main one being a large electric motor that can drain a battery system within 40 to 200 miles. This will also overcome rotor stall. By inserting a mechanical advantage device as the prime mover, a much smaller electric demand can be immediately realized thereby increasing the mileage range of said vehicle. Certain gear charts indicate 120 HP for a single flywheel with a 24 inch diametrial pitch rotating at 1800 rpm. Flywheels and rotors with a 12 to 30 inch D.P. and a web thickness of 12 inches or more, (barrel or roller shaped or base joined cone shaped), would allow much higher rotational speeds but would probably be restricted to front wheel drive type vehicles. When used in conjunction with voltage multiplier networks and alternating battery banks or a generator that is coupled to the output shaft or meshed to the starter ring gear, a continuous powering and/or regeneration situation can be realized to keep the alternate battery system at full charge condition or provide a feedback loop to power the electromagnets.

### PREFERRED EMBODIMENT

The preferred embodiment of the device for electric vehicle propulsion specifies a minimum of one, (1), anisotropic type rotor with a minimum dedendum circle diameter of 24 inches, being splined directly to a coaxial main output shaft and being driven or rotated around that common axis by electromagnet/electromagnetic coils which are mounted on the outer circumference of a circular engine housing or block. Said rotor is combined side by side and coaxially with two, (2), freely rotating flywheels also with a minimum dedendum circle diameter of 24 inches and also driven by electromagnetic coils about the common axis. Extending from the electromagnets, magnetic field extension pieces approach the embedded rotor and flywheel permanent magnets through the engine block housing at standard involute gear pitch/pressure angles of 14.5 or 20 degrees unless otherwise specified at 30, 45 or 90 degrees off tangent with the rotor or flywheel edge.

Both flywheels and rotors are friction coupled coaxially by means of automotive type clutch friction discs and steel or cast iron pressure plates. Contact between the individual

Members is maintained by the pressure received from pressure wedges and springs in the clutch discs and thrust bearing/contact washers located coaxially on the outer sides of the outer rotors. Certain gear charts indicate 120 HP for a single flywheel with a 24 inch diametrial pitch rotating at 1800 rpm.

Both flywheel(s) and rotor(s) are readily machined, (machinability index B), from 6061 T-6 aluminum plate stock and are 2 to 3 inches thick at the rim. They can be either machined monolithically or welded on rim type. The flywheel(s) have a ½ inch wide by ½ inch deep groove running around the outer edge of the rim to guide on the mating ridge of the inner circumference of the engine manifold. Both flywheel(s) and rotors are recessed ½ inch on both sides from hub to rim to allow the pressure plate to be bolted through the web of the member to the corresponding pressure plate on the opposite side.

### BRIEF DESCRIPTION OF THE DRAWINGS

FIG. 1 is a side view of a electromagnet driven pulsed magnetic-signal flux engine.

FIG. 2 is a sectional view of the preferred embodiment or configuration of FIG. 1.

FIG. 3 is a containment ring base or engine block.

FIG. 3b is an edge and sectional view of one and triple flywheel-rotors configurations.

FIG. 4 is a containment ring manifold or top piece.

FIG. 4b is an edge and sectional view of a containment ring manifold.

FIG. 5 is a side or back end plate showing timing/lateral booster attachment point.

FIG. 6 is a laterally aligned permanent magnet splined hub rotor with pressure plates.

FIG. 6b is an edge and sectional view of the splined hub rotor of FIG. 6.

FIG. 6c is a laterally aligned magnet press fitted splined hub rotor of the FIG. 6 type.

FIG. 6d is an edge and sectional view of the press fitted hub rotor of FIG. 6c.

FIG. 6e is an edge and sectional view of FIG. 6c with polarity gap magnets.

FIG. 7 is a laterally aligned permanent magnet pressed bearing flywheel.

FIG. 7b is an edge and sectional view of the pressed bearing flywheel of FIG. 7.

FIG. 7c is a splined press fitted hub with press fitted bearing flywheel of the FIG. 7 type.

FIG. 7d is an edge and sectional view of the press fitted hub flywheel of FIG. 7c.

FIG. 8 is a welded rim, radially aligned permanent or electromagnet pressed bearing flywheel.

FIG. 8b is an edge and sectional view of the pressed bearing flywheel of FIG. 8.

FIG. 8c is a splined press fitted hub of the FIG. 8 type.

FIG. 8d is an edge and sectional view of FIG. 8c.

FIGS. 9 and 9b is a “sawtooth” electromagnet rotor with pressed keyed hub and contact rings.

### NUMBER DESCRIPTION OF THE PREFERRED EMBODIMENT

10 is an electromagnetically driven pulsed magnetic-signal flux engine.

20 is a rotor, springs and pressure plates in assembly.

30 is a flywheel, springs and pressure plates in assembly.

40 is a drive shaft or main shaft.

50 is a bearing.

60 is a bearing.

70 is a sleeved permanent magnet.

80 is a friction disc assembly.

90 is a containment ring base or block.

100 is a containment ring manifold or top piece.

110 is an end plate or side plate.

120 is an electromagnet with mounting brackets and field extenders.

130 is an expandable seal.

140 is a starter ring gear and machine screw.

150 is an expansion ring or spacer ring.

160 is an attachment point and access port for timing devices or lateral booster magnets.

### DETAILED DESCRIPTION OF THE PREFERRED EMBODIMENT

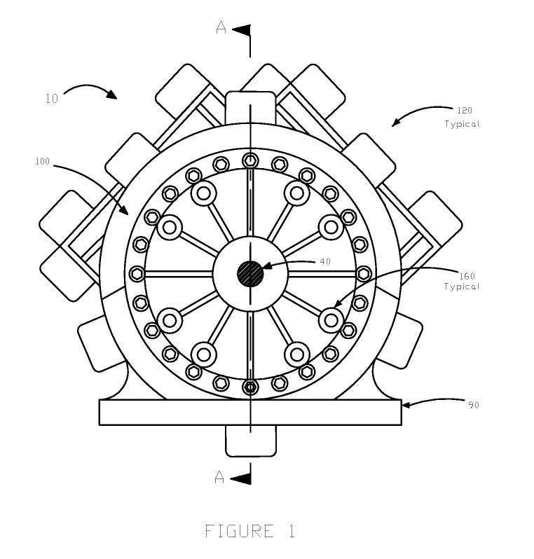

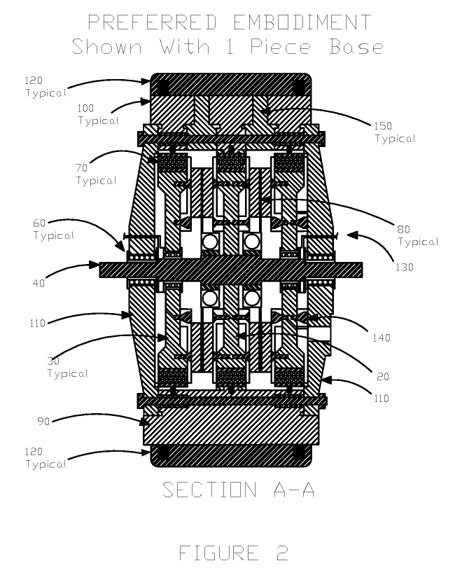

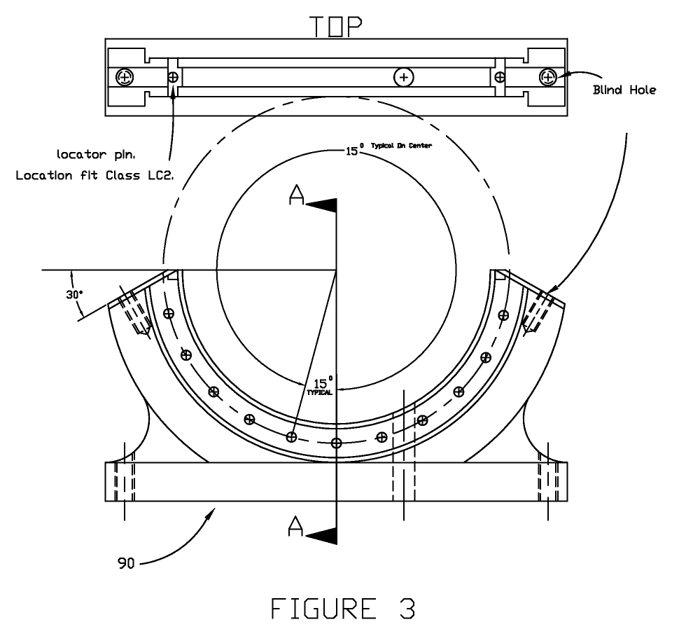

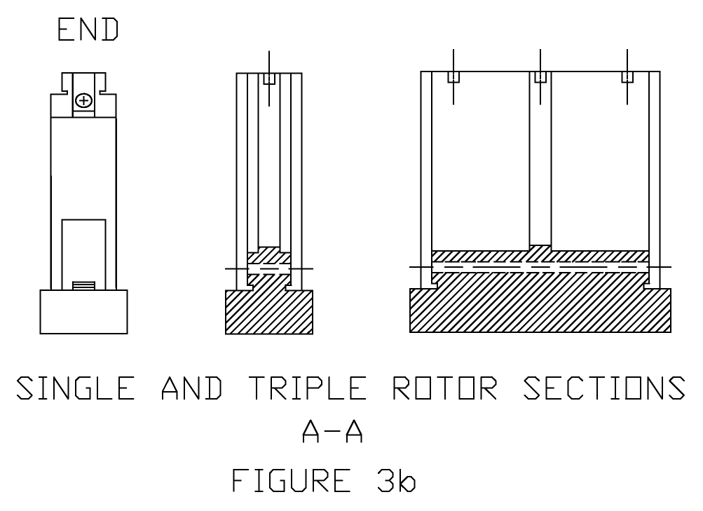

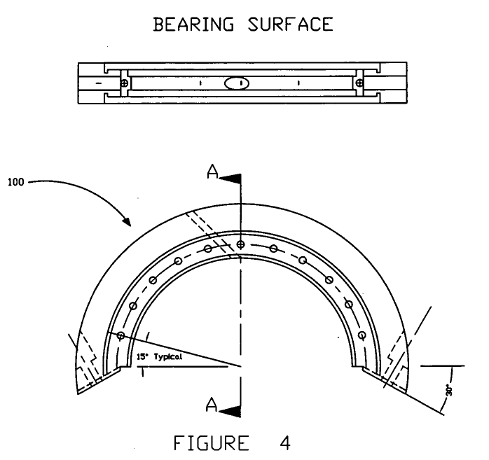

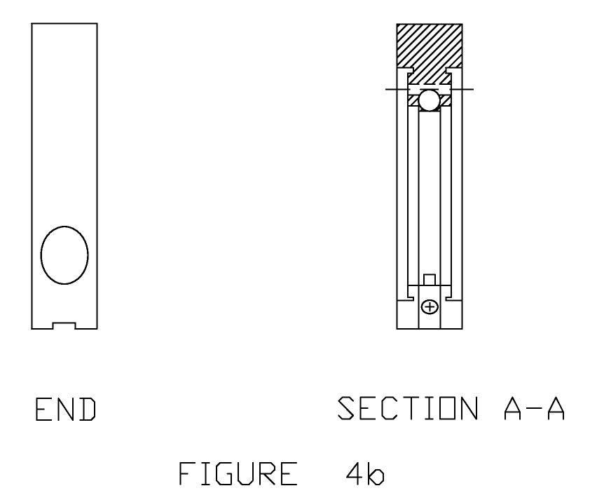

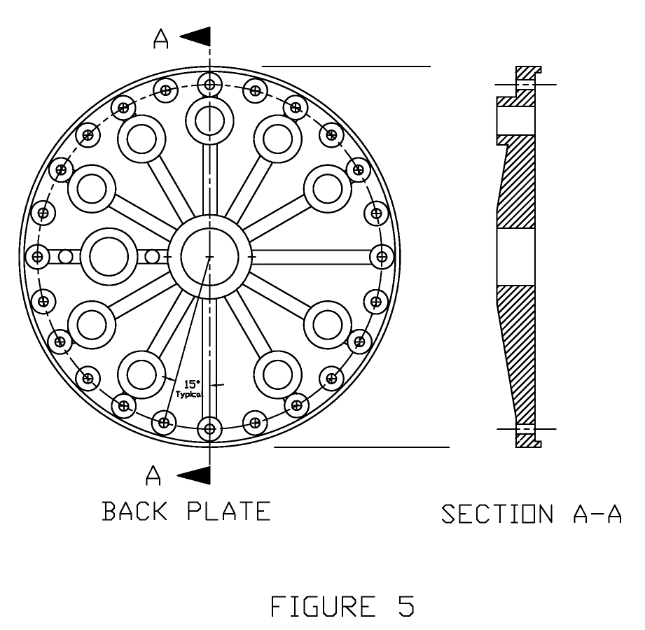

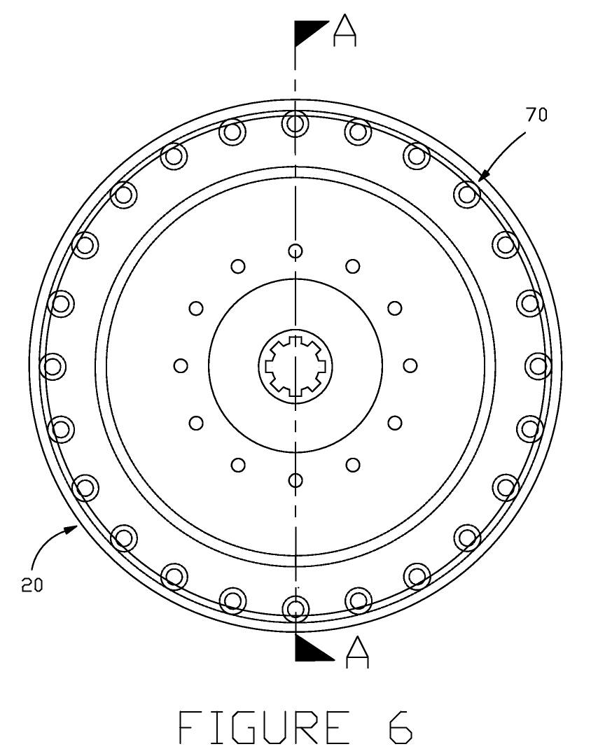

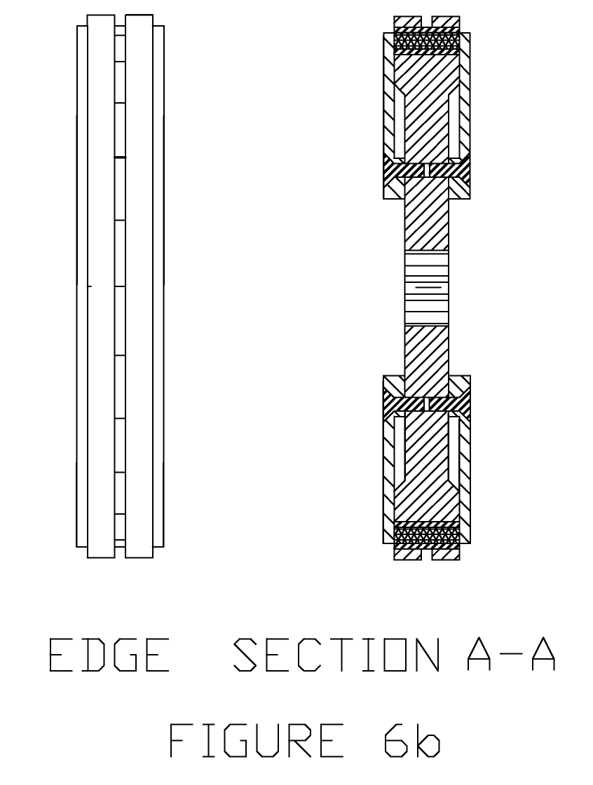

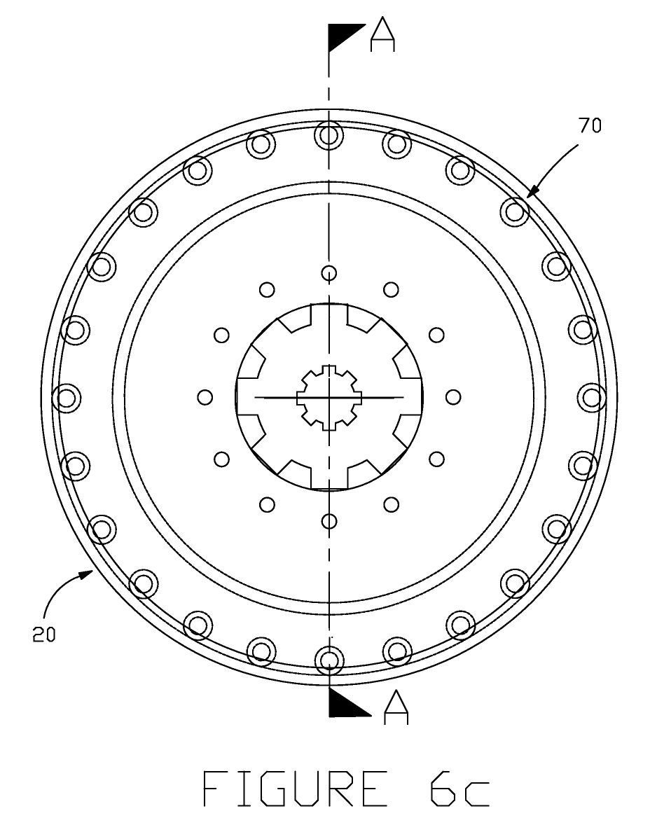

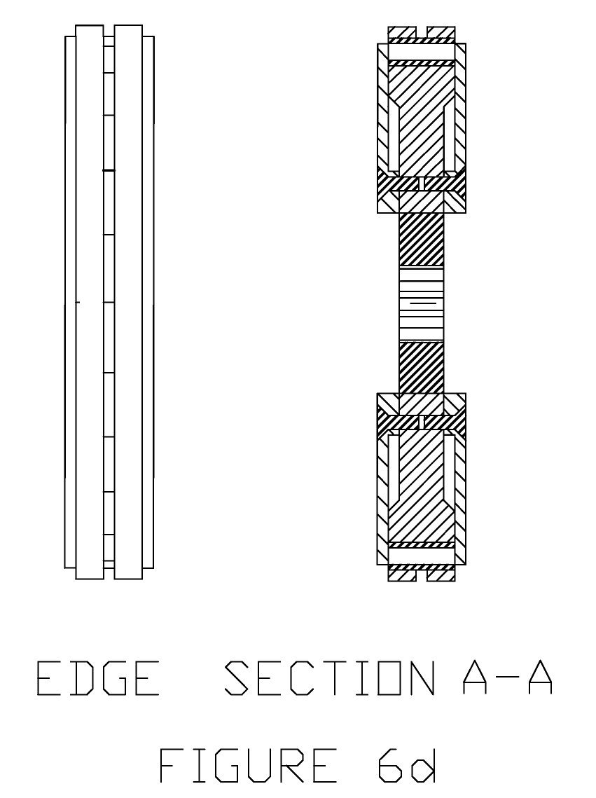

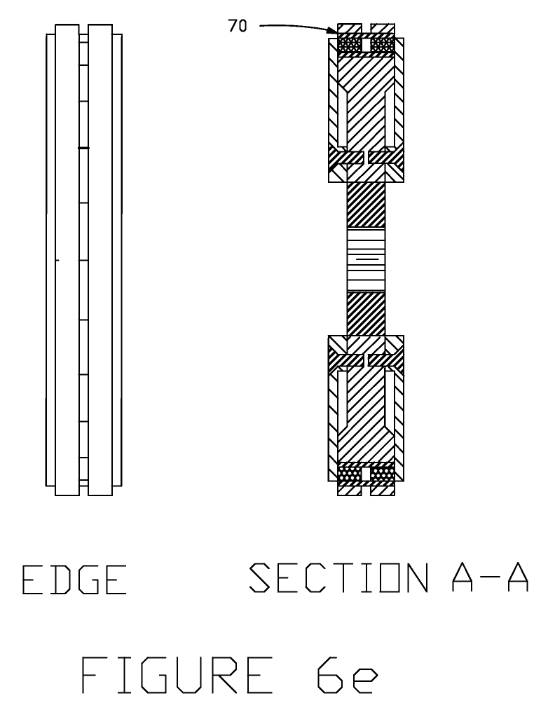

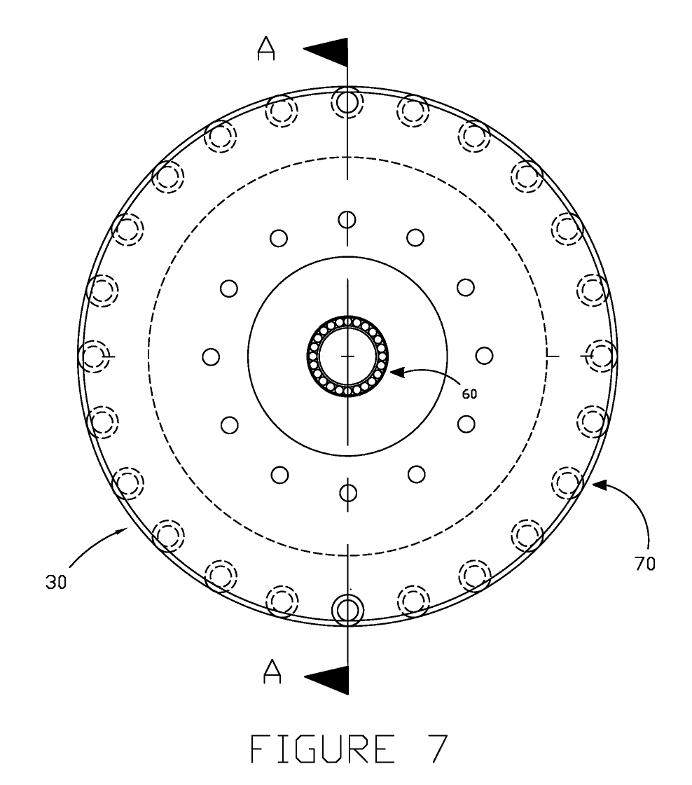

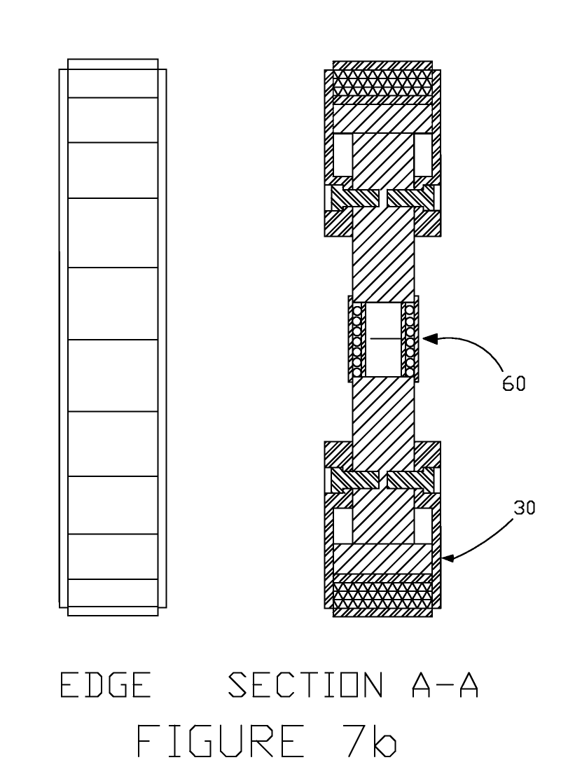

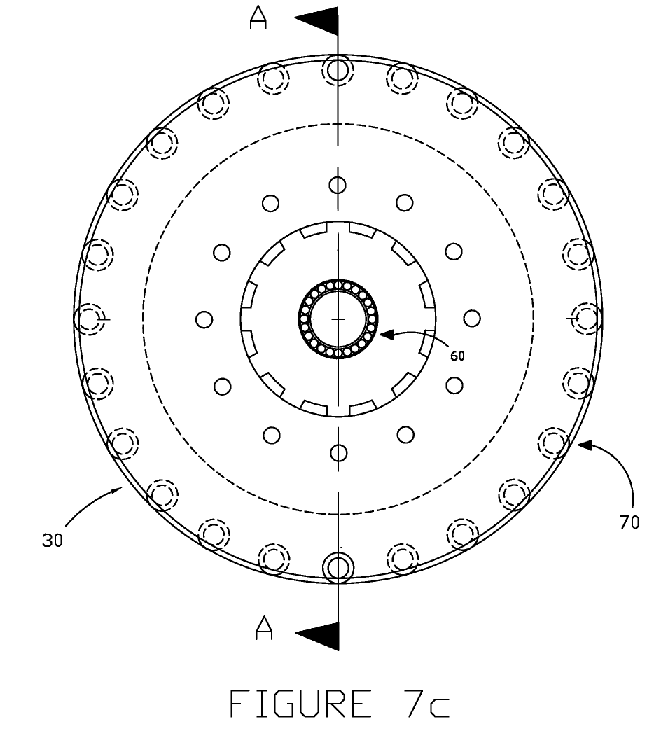

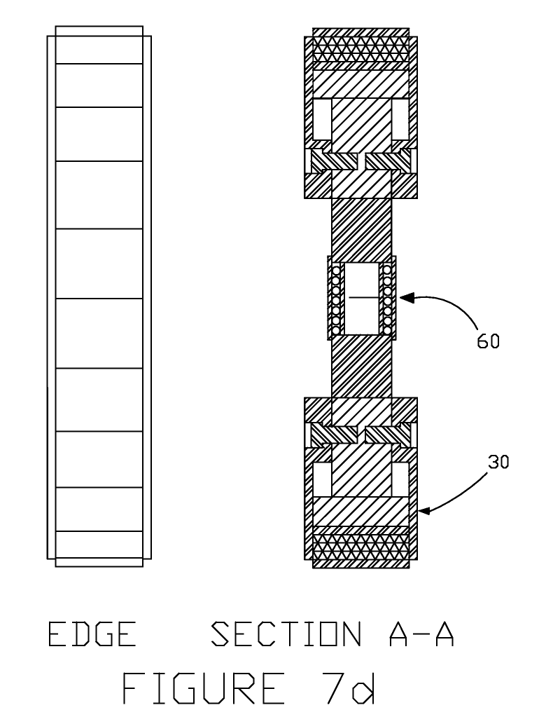

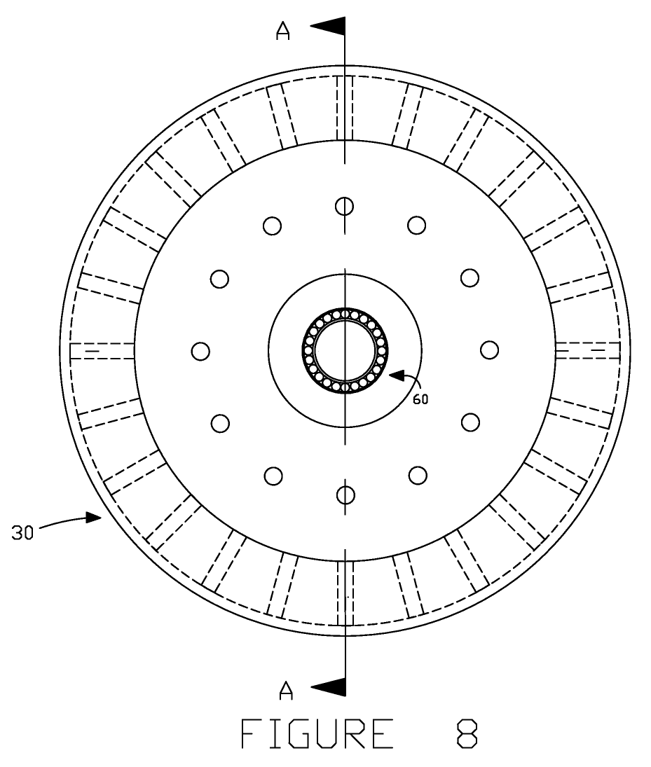

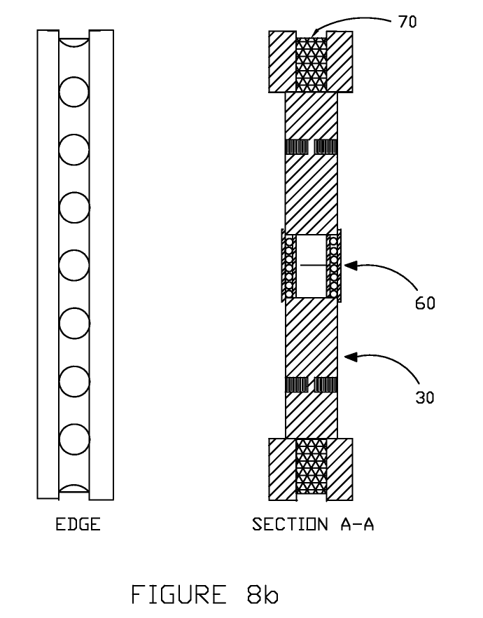

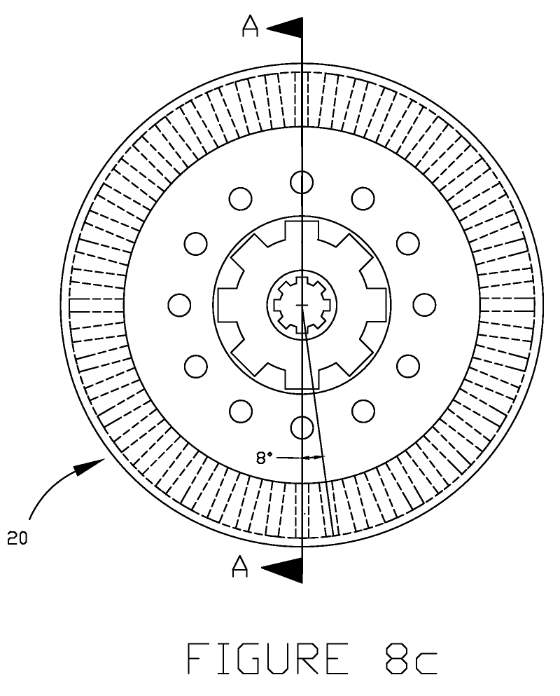

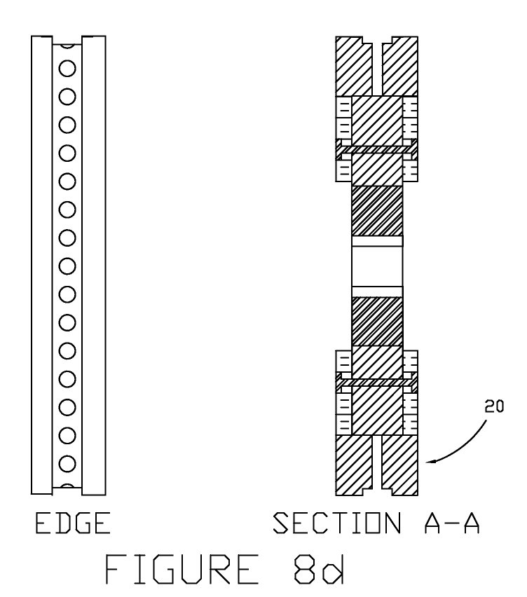

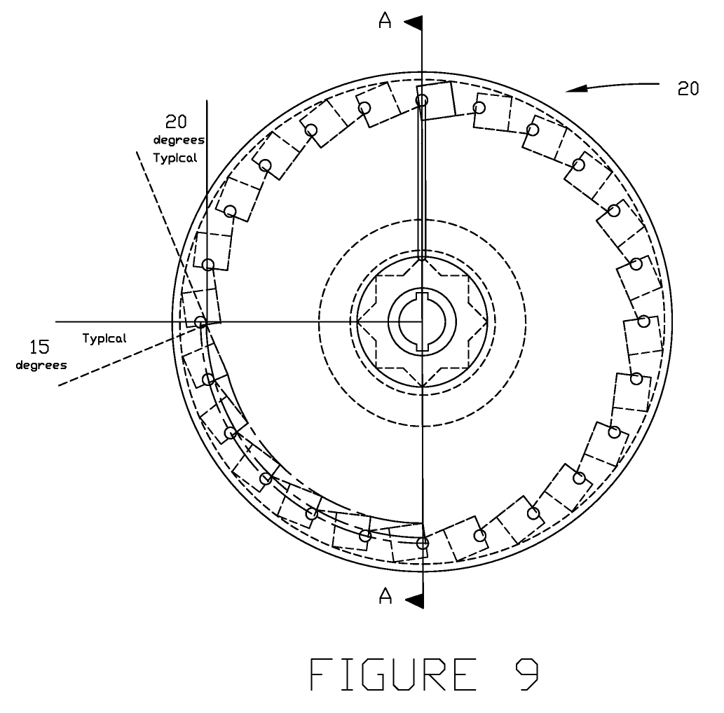

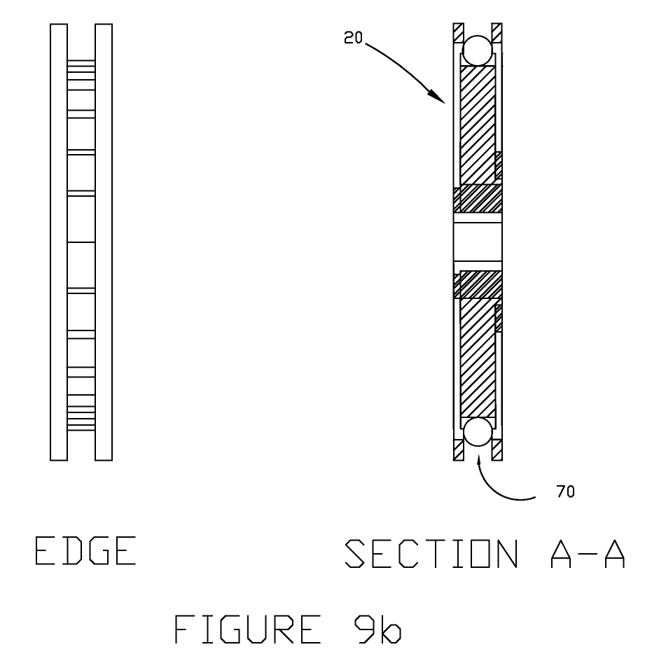

Referring to FIG. 1, a mechanical assembly 10, according to the present invention is shown in side view.

Referring to FIG. 2, in the preferred embodiment, a rotor and pressure plate assembly, 20, is splined to the main shaft, 40, and located within the combined base, 90, and manifold, 100, containment ring assembly. Two friction discs, 80, are splined to or journalled on bearings to the main shaft, 40, adjacent to and coaxial with the rotor and pressure plate(s) assembly, 20. Two flywheel and pressure plate assemblies, 30, are journalled on bearings, 60, to the main shaft, 40, and are nested in the combined base, 90, and manifold, 100, containment ring assembly. Expandable seals and thrust washers, 130, are slip fitted to the main shaft, 40, adjacent to the outer sides of the outer most rotor and pressure plate assemblies on both sides of the engine. Drip or pressure lubricated bearings, 60, are press fitted into the end or side plates, 110, and support the entire main shaft, 40, with the combined flywheel-rotor-friction disc and pressure plate assemblies, 20, 30, 80 and 130. The left side plate, 110, is bolted through the entire containment ring base, 90, and manifold, 100, containment ring assembly to the opposite right side plate, 110B and transfers the load of the said internal assembly, 20, 30, 40, 80, 130, etc., to the support tabs or feet of the engine base or block, 90. A commercially available electric automotive starter motor is bolted to the right side plate, 110B, and engages the starter ring gear, 140, to initiate rotation of the said internal assembly, 20, 30, 40, 80, 130, etc.

The embodiments of the invention in which an exclusive property or privilege is claimed are defined as follows:

1. An improved mechanical configuration consisting of a plurality of:
coaxial anisotropic-rimmed type rotors and flywheel(s), friction discs, pressure plates, thrust bearings/springs, in assembly with and coaxial with one, (1), main output shaft with splined and gland bolted attachment flanges or pulleys. For purposes of this design, the term rotor denotes a member or members of the apparatus that are splined to, keyed to, staked to, welded to or machined as an integral part of the above mentioned main output shaft. For purposes of this design, the term flywheel denotes a plurality of members of the apparatus that are adjacent to, on both sides of and coaxial with the above mentioned rotors but are free to rotate about the common axis independent of the rotor by means of a bearing that is press fitted into the flywheel hub and that bearing being press fitted onto said main shaft. For purposes of this design, each rotor and flywheel has a minimum diametrial pitch of 12 inches with the preferred embodiment of each rotor and flywheel having a minimum diametrial pitch of 24 inches. Each flywheel and rotor has radially positioned, steel sleeved permanent magnets embedded about and just inside the diametrial pitch. For purposes of this design the term friction disc denotes a plurality of members that are adjacent to and in between each rotor and flywheel combination and/or flywheel and flywheel combination, which then impart rotational force from the flywheel(s) to the rotor(s) by means of machined steel or cast iron pressure plates which are attached to the sides of each flywheel and rotor. There is theoretically no limit to the total number of sets of rotor and flywheel combinations but the preferred embodiment of this design is two flywheels and two friction discs per single rotor; one of each on each side of said rotor. The friction coefficient of each member is maintained by a thrust bearing, which is coaxial with and located adjacent to and on the outer side of the outer most flywheel on both sides of the machine as well as expansion springs placed between each flywheel/rotor and its' respective pressure plate; mounted on the pressure plate mounting bolts.

2. The mechanical assembly of claim 1 wherein the entire assembly is contained within a cylindrically shaped container. Said container, cut laterally, is comprised of a bottom portion which is termed the base and a top portion which is termed the manifold. The completed cylinder acts as both a mounting fixture and containment ring for the enclosed sets of flywheel and rotor combinations and is termed the engine or motor block. The completed cylinder has end plates also known as side plates bolted to each end which by means of a coaxial bearing supports the entire assembly of claim 1.

3. The mechanical assembly of claim 2 wherein the outer circumference of the engine block has electromagnetic coils, field extenders and mounting brackets bolted in place as prescribed in the drawings to drive the combination of rotors and flywheel(s) about their common axis thereby imparting rotational force or torque to the main shaft.
